(19) United States
(12) Patent Application Publication
(10) Pub. No.: US 2011/0044784 A1
(43) Pub. Date: Feb. 24, 2011

(54) ANTI-THEFT FIXING DEVICE FOR SECURING A WHEEL TO THE HUB OF A MOTOR VEHICLE

(75) Inventors: Richard Da Fonseca, Poissons (FR); Alain Froeliger, Froncles (FR)

Correspondence Address: Andrew W. Chu, PC, P. O. Box 2925, Houston, TX, 77252-2925, US

(73) Assignee: SOCIETE DES FORGES DE FRONCLES, Froncles (FR)

(21) Appl. No.: 12/988,786

(22) PCT Filed: Apr. 16, 2009
(86) PCT No.: PCT/FR2009/050703

§ 371 Date: Oct. 20, 2010

(30) Foreign Application Priority Data
Apr. 23, 2008 (FR) 0852723

(51) Int. Cl. F16B 33/00

(52) U.S. Cl. 411/366.1

(57) ABSTRACT

Anti-theft fixing device for securing a wheel to the hub of a motor vehicle, including a threaded part and a driving part having a cylindrical head and a sleeve-like insert with coupling indentations on its exterior. The insert is force-fitted onto the cylindrical head into a first use position, while being able to assume a second position in which it is engaged more deeply around the cylindrical head. The insert is coupled rotationally to the cylindrical head through friction mechanisms, the cylindrical head and the insert being configured in such a way that in the first position the friction mechanisms are capable of transmitting a tightening or loosening torque, while in the second position these friction mechanisms are not capable of transmitting this torque.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to an anti-theft fixing device for making a wheel integral with the hub of a motor vehicle, comprising a threaded part, a maintaining part aimed at being applied against an object to be fixed, and a driving part aimed at being inserted into a well of said wheel, and which permits a transmission to said threaded part of a tightening or loosening torque through a wrench or the like, the coupling of the wrench or the like with said driving part occurring through matching indentations on the one hand this driving part and on the other hand this wrench or the like include, the shape, dimension and arrangement characteristics forming a code.

2. Description of Related Art Including Information Disclosed Under 37 CFR 1.97 and 37 CFR 1.98.

Usually, the wheel of a motor vehicle is fixed by means of screws the head of which permitting the transmission of the tightening or loosening torque has a hexagonal shape.

In order to impede a third party from fraudulently removing the wheels, it is increasingly often proposed that, for each of the wheels, at least one of the screws has a head that requires a particular wrench for being maneuvered.

Numerous screw devices or the like provided with coding means are thus known, such as for example those described in GB 2.006.371, FR 2.359.730 and FR 2.567.215 and WO 03/081057. These devices comprise on the one hand a screw the head of which has either peripheral and/or facial notches angularly arranged in an irregular way, and on the other hand a socket-like wrench provided with pins or catches arranged according to the same arrangement and aimed at cooperating with said notches in order to bring about the coupling likely to permit the transfer of the torque.

The inviolability of these devices is increased when their head is driven into a narrow well that impedes its seizing through approaching the head from the side by means of a tightening tool. In this case, the fraudulent aggressions against these devices occur by force, either through an axial and slightly oblique attack with a chisel or using a wrench having another code, or part of the code, and axially pressing against the coded head.

### SUMMARY OF THE INVENTION

The aim of the present invention is to provide an anti-theft fixing device that cannot be forced by an approach with force in an axial direction.

The anti-theft fixing device for making a wheel integral on the hub of a motor vehicle according to the invention includes a threaded part, a maintaining part aimed at being applied against the object to be fixed, and a driving part aimed at being inserted into a well of said wheel, and which permits the transmission to said threaded part of a tightening or loosening torque through a wrench or the like, the coupling of the wrench or the like with said driving part occurring through matching indentations on the one hand said driving part and on the other hand said wrench or the like include, the shape, dimension and arrangement characteristics of said indentations forming a code, and is essentially characterized in that said driving part includes on the one hand a cylindrical stud that extends axially, and on the other hand a sleeve-shaped insert including externally said indentations that permit the coupling of a wrench or the like, and which is inserted axially with force onto said cylindrical stud so as to adopt a first position of use, while being likely to adopt a second position in which it is inserted deeper around said cylindrical stud, and in that said insert is connected in rotation to said cylindrical stud through friction means, said cylindrical stud and said insert being configured so that in said first position said friction means are capable of permitting to ensure the transmission of the tightening or loosening torque, while in said second position said friction means are unable to permit the transmission of said torque.

The friction means are arranged either on the stud or on the insert and, as the case may be, the insert or the stud, respectively, is configured so that, in the event the insert passes into the second position, the friction means are, at least partially, in front of an area, for example emptied an area, that does not allow them a sufficient adhesion for transmitting the torque necessary for the tightening or loosening.

According to an additional feature of the anti-theft fixing device according to the invention, the friction means consist of axial grooves that extend on the inner wall of the insert, or on an outer wall of the cylindrical stud.

According to a particular embodiment of the anti-theft fixing device according to the invention, the cylindrical stud has two stages with different diameters, a first stage away from the maintaining part, and a second stage intercalated between the first one and said maintaining part, the second stage having a diameter smaller than that of said first stage, while the friction means are arranged on the inner wall of the insert.

According to another particular embodiment of the anti-theft fixing device according to the invention, the cylindrical stud has a constant diameter and includes externally the friction means arranged at a certain distance from its base, while the insert has internally two stages with different diameters, a first stage, on the side of the orifice for insertion onto said stud, and a second one, on the other side, the latter having a diameter larger than that of the other stage.

According to another additional feature of the anti-theft fixing device according to the invention, the insert includes externally a flange in which the indentations are provided for.

According to another additional feature of the anti-theft fixing device according to the invention, the insert extends proximate the orifice for insertion onto said stud.

According to another additional feature of the anti-theft fixing device according to the invention, the insert has a height at least equal to that of the cylindrical stud.

The advantages and the features of the anti-theft fixing device according to the invention will become clear from the following description, which refers to the attached drawing, which represents a non-restrictive embodiment of same.

### BRIEF DESCRIPTION OF THE DRAWINGS

FIG. 1 shows a schematic perspective and exploded view of an anti-theft fixing device according to the invention.

FIG. 2a shows a schematic and axial cross-sectional view of an anti-theft fixing device according to the invention, in a situation of utilization.

FIG. 2b shows the same schematic and axial cross-sectional view, after an attempt to force it.

FIG. 3a shows a partial schematic and axial cross-sectional view of a detail of FIG. 2a.

FIG. 3b shows a partial schematic and axial cross-sectional view of a detail of FIG. 2b.

### DETAILED DESCRIPTION OF THE DRAWINGS

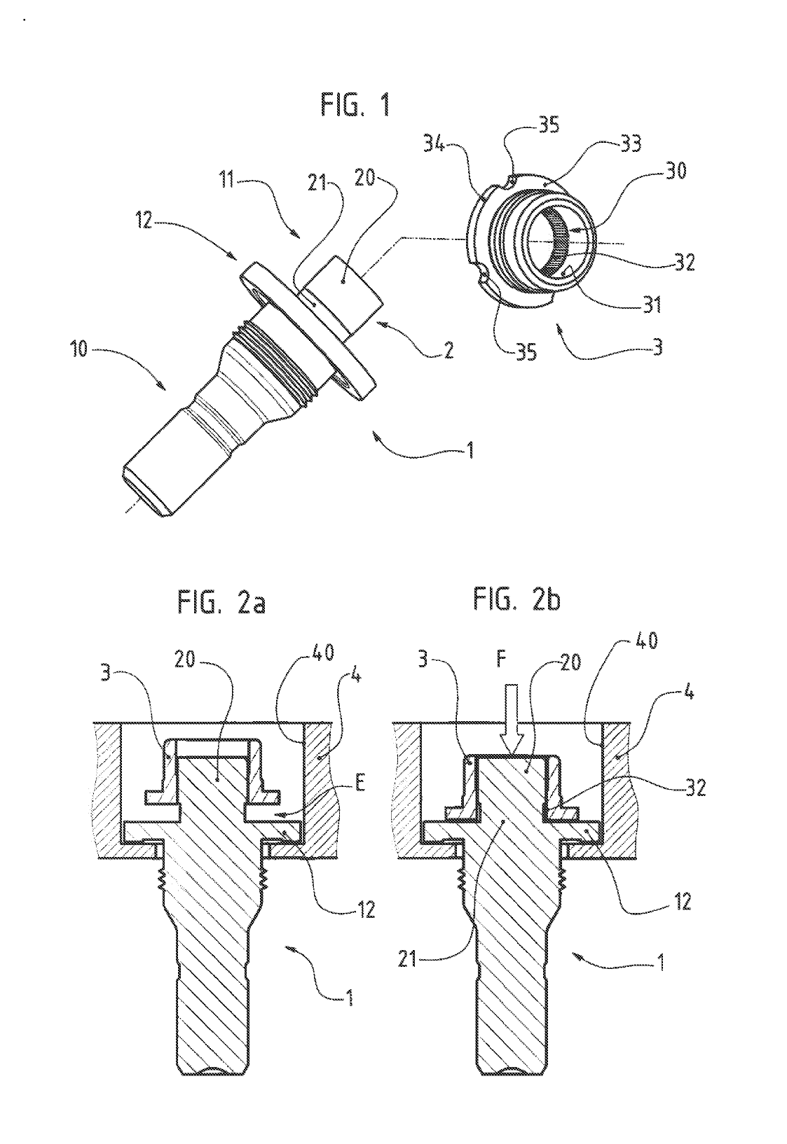

When referring to FIG. 1, one can see an anti-theft fixing device according to the invention, which is in the form of a screw 1. The latter includes a distal portion 10 aimed at being screwed into a tapped hole of the hub, and a proximal portion 11 aimed at permitting its maneuvering in axial rotation.

The distal 10 and proximal portions 11 are separated by an intermediate portion 12, which is in the form of a disc aimed at bringing about the retaining of the object to be fixed, in this case the rim of a wheel.

According to the invention, the proximal portion 11 comprises a cylindrical stud 2 that protrudes axially out of the upper face of the intermediate portion 12 and, in this embodiment, has two stages with different diameters, namely an extreme stage 20, and, at the level of its base, i.e. in its junction area with the disc-shaped intermediate portion 12, a stage 21 with a diameter smaller than that of the stage 20.

The proximal portion 11 also comprises an insert 3, which is in the form of a sleeve that includes an opening 30 that permits same to be inserted onto the cylindrical stud 2.

The inner wall 31 of the insert 3 includes at the periphery axial grooves 32, which are so dimensioned as to permit to connect in rotation the insert 3 with the cylindrical stud 2.

The insert 3 is thus aimed at being fixed by force onto the cylindrical stud 2, and in particular onto the stage 20 of the latter, while being maintained on it through the grooves 32.

Furthermore, the insert 3 externally includes a flange 33 in the edge 34 of which notches 35 are provided for, which permit adapting a tool for maneuvering in rotation the insert 3 and, hence, the screw 1.

In a well-known way, the dimensions of the notches 35 and their arrangement at the periphery of the flange 33 define an indentation forming a code.

When referring now to FIG. 2a, one can see a screw 1 according to the invention, inserted into the well 40 of a rim 4.

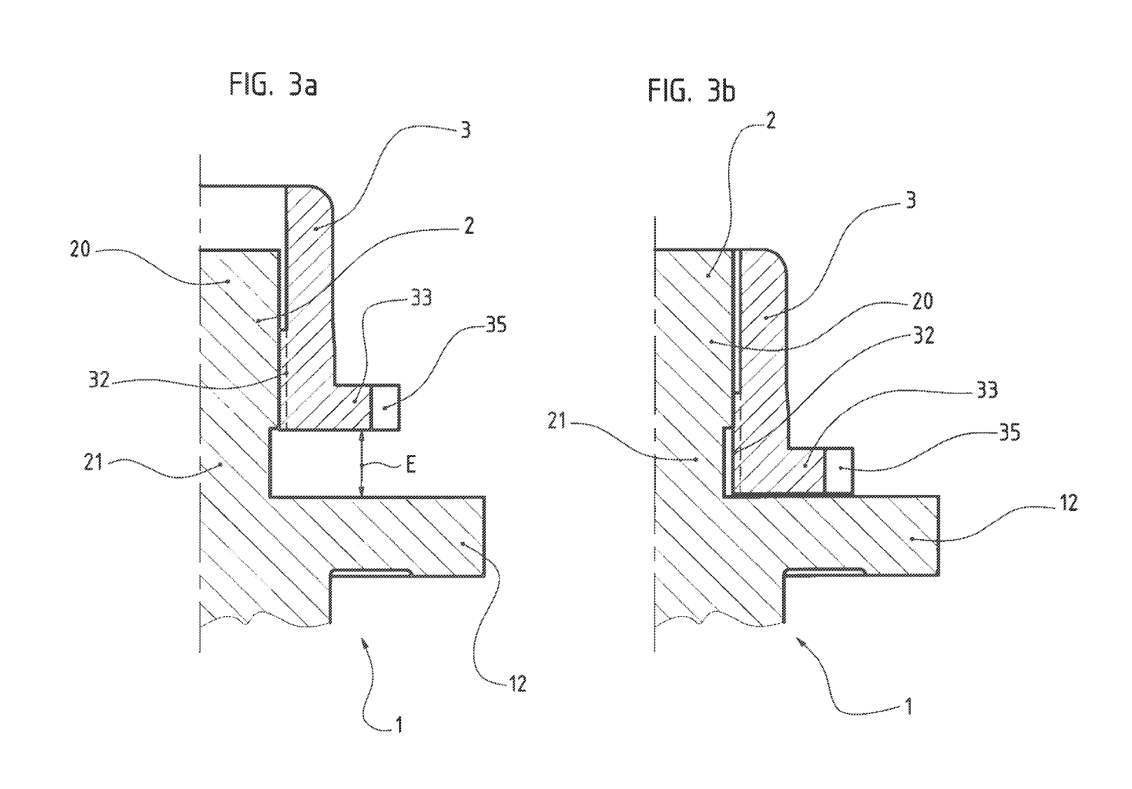

As can be seen in FIG. 3a, the insert 3 is crimped onto the stage 20 of the cylindrical stud 2, leaving a space E between the insert 3 and the upper face of the intermediate portion 12.

In this configuration, the grooves 32 ensure sufficient friction to permit, during the maneuver in rotation of the insert 3, the transmission of the torque necessary to tighten or to loosen the screw 1.

When referring now to FIGS. 2b and 3b, one can see that, during an attempt to force the device generating an axial force F onto the insert 3, the latter is pushed back against the intermediate portion 12 and is positioned on the stage 21 of the stud 2, so that the grooves 32 are only partly into contact with the stud 2, and in particular the stage 20, thus limiting the friction between both elements, and impeding the transmission of a loosening torque.

It should be noted that, in this particular embodiment, the grooves 32 extend over a height that is larger than the height of the stage 21, so that a contact remains between them and the stage 20, which thus ensures a maintaining of the insert 3.

It should also be noted that, according to a variant, the friction means are arranged on the stud 2, while the wall 31 of the insert 3 has two stages with different diameters. This variant has however the drawback that, in the event the insert 3 is removed, the friction means of the stud 2 promote the seizing of the latter by means of a tightening tool.

The form and the dimensioning of the insert 3, as well as the positioning of the flange 33 on the bottom of a well 40, make impossible the use of multi-pin wrenches, which are generally used to force the screws with a code.

It should be noted that the dimensions of the insert 3, and in particular the diametrical ones, of the flange 33 are chosen depending on the diametrical dimensions of the well 40, so as not to permit the passing through of an extraction tool.

In case a chisel or any other cutting tool is used, the insert 3 can be cut or split, and the torque can no longer be transmitted.

Finally, as we have seen above, in the event the insert 3 is axially forced by means of a wrench with a close code stamped by hammering, the insert 3 is inserted onto the stud 2, which impedes the transmission of the loosening torque.

It should be noted that the insert 3 has preferably a height equal to that of the stud 2, which, when the insert 3 is inserted onto the stud 2, impedes the latter from being seized by means of a tightening tool.

1. Anti-theft fixing device for making a wheel integral on the hub of a motor vehicle, the device comprising:
a threaded part,
a maintaining part aimed at being applied against the object to be fixed, and
a driving part aimed at being inserted into a well of said wheel, permitting transmission to said threaded part of a tightening or loosening torque through a wrench or the like, the coupling of the wrench or the like with said driving part occurring through matching indentations on said driving part and on said wrench or the like, shape, dimension and arrangement characteristics of said indentations forming a code, wherein said driving part further comprises a cylindrical stud extending axially, and a sleeve-shaped insert being comprised of externally said indentations that permit the coupling of a wrench or the like, said insert being inserted axially with force onto said cylindrical stud so as to adopt a first position of use, while being likely to adopt a second position in which it is inserted deeper around said cylindrical stud, and wherein said insert is connected in rotation to said cylindrical stud through friction means, said cylindrical stud and said insert being configured so that in said first position said friction means ensure the transmission of the tightening or loosening torque, while in said second position said friction means are unable to permit the transmission of said torque.

2. Anti-theft fixing device according to claim 1, wherein the friction means are comprised of axial grooves that extend on the inner wall of the insert, or on the external wall of the cylindrical stud.

3. Anti-theft fixing device according to claim 1, wherein the cylindrical stud has two stages with different diameters, a first stage away from the maintaining part, a second stage intercalated between the first stage and said maintaining part, the second stage having a diameter smaller than that of said first stage, while the friction means are arranged on the inner wall of the insert.

4. Anti-theft fixing device according to claim 1, wherein the cylindrical stud has a constant diameter and comprises externally the friction means arranged at a certain distance from its base, while the insert has internally two stages with different diameters, a first stage, on the side of the orifice for insertion onto said stud, and a second one, on the other side, the latter having a diameter larger than that of the other stage.

5. Anti-theft fixing device according to claim 1, wherein the insert further comprises externally a flange in which the indentations are provided for.

6. Anti-theft fixing device according to claim 5, wherein the insert extends proximate the orifice for insertion onto the stud.
